(19) United States
(12) Patent Application Publication
(10) Pub. No.: US 2026/0251484 A1
(43) Pub. Date: Aug. 27, 2026

(54) APPARATUS AND METHOD FOR OPTIC FIBER MEASUREMENT BASED ON BRILLOUIN OPTICAL CORRELATION DOMAIN ANALYSIS USING PULSE WAVEFORM CONTROL OF BITS

(71) Applicant: Dong-A University Research Foundation For Industry-Academy Cooperation, Busan (KR)

(72) Inventor: Bo Hun CHOI, Busan (KR)

(73) Assignee: Dong-A University Research Foundation For Industry-Academy Cooperation, Busan (KR)

(21) Appl. No.: 19/274,828

(22) Filed: Jul. 21, 2025

(30) Foreign Application Priority Data
Feb. 18, 2025 (KR) 10-2025-0021063

(51) Int. Cl. G01D 5/353; G01D 5/36

(52) U.S. Cl. CPC G01D 5/35364; G01D 5/366

(57) ABSTRACT

An apparatus for optic fiber measurement based on Brillouin optical correlation domain analysis using pulse waveform control of bits is disclosed, the apparatus including a PRBS generation unit generating electrical two identical electrical pulse pattern signals so that a probe optical signal and a pump optical signal have a time difference, and generating a first PRBS signal and a second PRBS signal by distorting a per-bit pulse waveform of each two pulse pattern signals; a probe phase modulation unit performing phase modulation of the probe optical signal according to the first PRBS signal; a pump phase modulation unit performing phase modulation of the pump optical signal according to the second PRBS signal; and a BOCDA sensor unit measuring Brillouin gain spectrum by inputting the probe optical signal and the pump optical signal with the time difference to both ends of a sensing optical fiber.

### CROSS REFERENCE TO RELATED APPLICATION

The present application claims priority to Korean Patent Application No. 10-2025-0021063 filed February 18, 2025, the entire contents of which are incorporated herein for all purposes by this reference.

### BACKGROUND OF THE INVENTION

### FIELD OF THE INVENTION

The present disclosure relates to an optic fiber measurement technology based on Brillouin optical correlation domain analysis.

### DESCRIPTION OF THE RELATED ART

An optic fiber sensing technology with the Stimulated Brillouin Scattering (SBS) effect has been studied for the purpose of structural stability monitoring and environmental monitoring. The optic fiber sensing technology is largely divided into BOTDA (Brillouin Optical Time Domain Analysis) and BOCDA (Brillouin Optical Correlation Domain Analysis). Although BOTDA may perform measurements over an optical fiber length of 100 km or more, it is difficult to achieve a spatial resolution below 1 m, and it has limitations in achieving it to tens of cm or less even with special technology. BOCDA has the advantages of superior spatial resolution and real-time point-to-point measurement compared to BOTDA, even in the case of the measurable optical fiber length of several kilometers.

BOCDA performs measurements using the positions of multiple correlation peaks, which are SBS gains generated when probe signals and pump signals moving in opposite directions across both ends of an optical fiber meet at a specific position of the optical fiber. The spatial resolution and measurement length of BOCDA are determined by which of the multiple correlation peaks is selected. The conventional BOCDA determines the needed correlation peak by adjusting the length of the delay optical fiber. Such a conventional method using the delay optical fiber requires to change the length of the delay optical fiber whenever the length of the measurement optical fiber changes or the resolution needs to be changed, and causes vulnerability to temperature changes. In the conventional BOCDA methods, the modulation rate needed to be continuously varied in order to change the measurement position.

Therefore, a time-differential BOCDA(TD-BOCDA)-based optical fiber measurement technology is proposed, which may determine the correlation peak position through a time difference between PRBS (Pseudo Random Bit Sequence) codes applied to pump signals and probe signals without using the delay optical fiber. Specifically, the time-differential BOCDA-based optical fiber measurement technology applies PRBS signals with the same bit sequence but different starting points, i.e., with a time difference, to the pump signals and the probe signals, respectively, to determine the correlation peak position. The time-differential BOCDA-based optical fiber measurement technology may simplify the configuration because it does not require to install the delay optical fiber, and so increase the freedom of the measurement device In addition, the modulation rate is fixed, so that the spatial resolution does not change over the entire measurement range. By using a constant modulation rate and, in particular, by eliminating the use of a delay line, the measurement system and process were simplified.

However, the spatial resolution of the time-differential BOCDA-based optical fiber measurement technology is determined by a time interval of one bit depending on the modulation rate. Since the bit modulation rate must be increased to make the spatial resolution finer, the modulation rate becomes an important limiting factor.

### SUMMARY OF THE INVENTION

Accordingly, the present disclosure has been made keeping in mind the above problems occurring in the related art, and the present disclosure has an objective to provide an apparatus and method for optic fiber measurement based on Brillouin optical correlation domain analysis using pulse waveform control of bits, which may achieve finer spatial resolution under the same bit modulation rate and measurement length conditions as the existing time-differential BOCDA-based optical fiber measurement technology by making a time difference between PRBS signals applied to probe signals and pump signals smaller than a time interval of one bit and distorting a pulse waveform.

The objective of the present disclosure is not limited to that mentioned above, and other objective not mentioned may be clearly understood from the description below.

In order to achieve the above-mentioned objective, according to an aspect of the present disclosure, an apparatus for optic fiber measurement based on Brillouin optical correlation domain analysis using pulse waveform control of bits includes a PRBS generation unit generating two identical electrical pulse pattern signals to be modulated in phase so that a probe optical signal and a pump optical signal have a time difference according to a pseudo-random bit sequence, the two identical electrical pulse pattern signals being generated to have the time difference in a sub-bit unit which is shorter than a time interval of one bit, and generating a first PRBS signal and a second PRBS signal by distorting a per-bit pulse waveform of each of the two identical electrical pulse pattern signals, a probe phase modulation unit performing phase modulation of the probe optical signal according to the first PRBS signal, a pump phase modulation unit performing phase modulation of the pump optical signal according to the second PRBS signal, and a BOCDA sensor unit having a sensing optical fiber and measuring a Brillouin gain spectrum by inputting the probe optical signal and the pump optical signal with the time difference, which is generated according to outputs from the probe phase modulation unit and the pump phase modulation unit, to both ends of the sensing optical fiber.

According to another aspect of the present disclosure, a method for optic fiber measurement based on Brillouin optical correlation domain analysis using pulse waveform control of bits includes generating two identical electrical pulse pattern signals to be modulated in phase so that a probe optical signal and a pump optical signal have a time difference according to a pseudo-random bit sequence, the two identical electrical pulse pattern signals being generated to have a time difference of a sub-bit unit shorter than a time interval of one bit, generating a first PRBS signal and a second PRBS signal by distorting a per-bit pulse waveform of each of the two identical electrical pulse pattern signals, performing phase modulation of the probe optical signal and the pump optical signal distributed from a light source according to the first PRBS signal and the second PRBS signal, respectively, and outputting the phase-modulated probe optical signal and the phase-modulated pump optical signal to both ends of a sensing optical fiber.

According to the present disclosure, it has the advantage of improving a spatial resolution compared to the existing time-differential BOCDA-based optical fiber measurement technology under the conditions of the same modulation rate.

According to the present disclosure, it has the advantage of improving the performance for the measurement of the strain applied to the optical fiber by allowing a fine spatial resolution of 1 mm or less to be provided over a long distance of at least 200 m or more.

The advantages of the present disclosure are not limited to the advantages mentioned above, and other advantages not mentioned will be clearly understood by those skilled in the art from the description of the claims.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram showing an apparatus for optical fiber measurement based on Brillouin optical correlation domain analysis using pulse waveform control of bits, according to an embodiment of the present disclosure;

FIG. 2 is a flowchart showing an apparatus for optical fiber measurement based on Brillouin optical correlation domain analysis using pulse waveform control of bits, according to another embodiment of the present disclosure;

FIG. 3 is a diagram showing the RF amplification result according to the cutoff frequency condition of the RF amplifier before electrical pulse pattern signals are input to the phase modulators of the probe and the pump;

FIG. 4 is a diagram showing the spatial resolution in the case of waveform distortion according to the existing time-differential BOCDA-based optical fiber measurement technology and embodiments of the present disclosure;

FIG. 5 is a diagram showing the Brillouin frequency of the optical fiber which is obtained by measuring a sensing optical fiber of 100 m with a DSF (Dispersion Shifted Fiber) of 5 mm and 10 mm using probe light and pump light having a modulation rate of 20 Gbps;

FIG. 6 is a diagram showing the Brillouin frequency according to the position, which is obtained by measuring a sensing optical fiber of 200 m with a DSF of 1 mm under the modulation rate condition of 20 Gbps using a sub-bit interval in embodiments of the present disclosure;

FIG. 7A is a diagram showing the Brillouin frequency spectrum measured while positioning a DSF of 1 mm at the end of a sensing optical fiber of 200 m and changing the frequency of a single-sideband modulation unit between 10.5 and 11 GHz; and

FIG. 7B is a diagram showing Brillouin frequency values extracted from FIG. 7A.

### DETAILED DESCRIPTION OF THE INVENTION

The advantages and features of the present disclosure, and the methods for achieving them, will become clear with reference to the embodiments described in detail below together with the accompanying drawings. However, the present disclosure is not limited to the embodiments disclosed below, but may be implemented in various other forms, and these embodiments are provided only to make the disclosure of the present disclosure complete, and to fully inform a person having ordinary skill in the art to which the present disclosure pertains of the scope of the invention, and the present disclosure is defined only by the description of the claims. Meanwhile, the terminology used in this specification is for the purpose of describing the embodiments, and is not intended to limit the present disclosure. In this specification, the singular includes the plural unless specifically stated in the phrase.

The present disclosure discloses a BOCDA sensor-based sensing technology that generates a correlation peak position by applying a time difference to probe optical signals and pump optical signals without a delay optical fiber using pulse pattern signals according to a PRBS (Pseudo Random Bit Sequence), and measures the Brillouin gain frequency in a sensing optical fiber as a result, thereby measuring a strain applied to the optical fiber.

In particular, the present disclosure has a technical feature of providing superior spatial resolution compared to the existing BOCDA sensor-based sensing technology at the same -modulation rate, by allowing the probe and pump optical signals with the same pseudo random bit sequence to have a time difference of a sub-bit time interval shorter than the time interval of one bit and distorting the pulse waveform of electric pulse pattern signals that modulates the probe and pump optical signals.

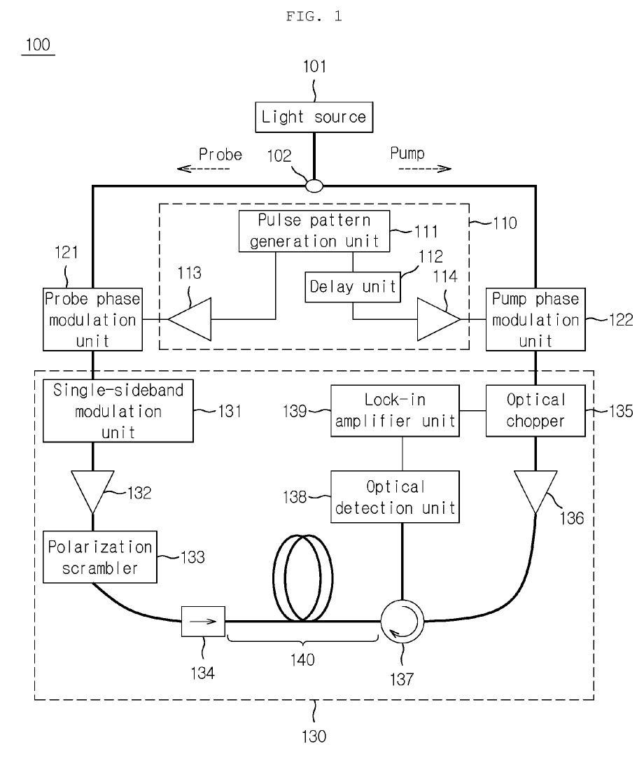

Referring to FIG. 1, an apparatus 100 for optical fiber measurement based on Brillouin optical correlation domain analysis using pulse waveform control of bits according to an embodiment of the present disclosure may be configured to include a light source unit 101, a distribution unit 102, a PRBS generation unit 110, a probe phase modulation unit 121, a pump phase modulation unit 122, and a BOCDA sensor unit 130.

The portions indicated by relatively thick lines in FIG. 1 (between reference numerals 101 and 102, between reference numerals 102 and 121, between reference numerals 102 and 122, between reference numerals 121 and 131, 140, etc.) mean that they are implemented with optical fibers.

The light source unit 101 may generate a single-frequency optical signal.

The distribution unit 102 may distribute the optical signal generated from the light source unit 101 into a probe optical signal and a pump optical signal.

The PRBS generation unit 110 may generate two identical electrical pulse pattern signals for performing phase modulation of the probe optical signal and the pump optical signal so that they have a time difference according to a pseudo-random bit sequence, the two identical electrical pulse pattern signals being generated so that they have a time difference in a sub-bit unit shorter than a time interval of one bit, and generate the first PRBS signal and the second PRBS signal by distorting per-bit pulse waveform of each pulse pattern signal.

The PRBS generation unit 110 may be configured to include a pulse pattern generation unit 111, a delay unit 112, a first RF amplifier 113, and a second RF amplifier 114.

The pulse pattern generation unit 111 may generate a first pulse pattern signal of a square wave according to a pseudo-random bit sequence.

The delay unit 112 may generate a second pulse pattern signal by delaying the first pulse pattern signal generated in the pulse pattern generation unit 111 in a sub-bit interval unit that are further divided within a time interval of one bit.

For example, the time delay degree may be adjusted with an accuracy of 1/2, 1/4, 1/5, 1/10, 1/20, etc. of one bit.

According to the configuration, the delay unit 112 may finely delay time by an interval shorter than the time interval of one bit.

According to an embodiment, the pulse pattern generation unit 111 may simultaneously generate the pulse pattern for the probe and the pulse pattern for the pump by determining the time order or the delay degree, thereby obtaining an effect similar to that of the delay unit, without using a physical electrical delay unit.

The first RF amplifier 113 may perform RF amplification of the first pulse pattern signal according to a cutoff frequency limited to block a low frequency by a predetermined ratio in a preset bandwidth, thereby generating a first PRBS signal in which the pulse waveform for each bit is distorted, from the first pulse pattern signal of a square wave.

The second RF amplifier 114 may perform RF amplification of the second pulse pattern signal according to a cutoff frequency limited to block a low frequency by a predetermined ratio in a preset bandwidth, thereby generating a second PRBS signal in which the pulse waveform for each bit is distorted, from the second pulse pattern signal of a square wave.

Here, the predetermined ratio may be 20% to 60%, but is not limited thereto.

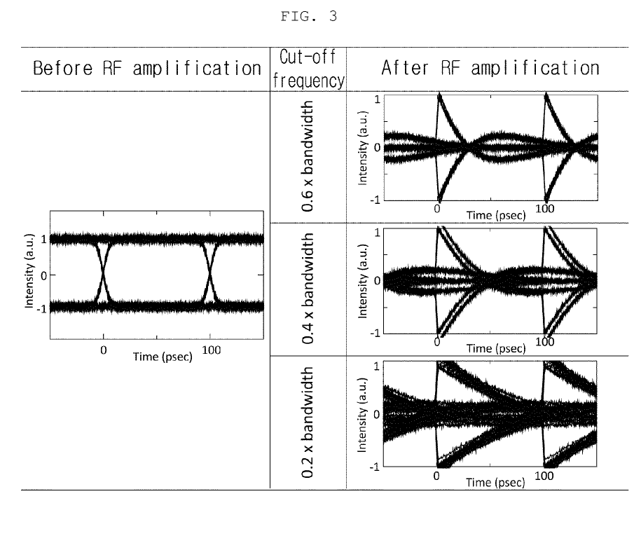

Referring to FIG. 3, the present disclosure may distort the pulse waveform for each bit by performing RF amplification in such a manner to block the low RF according to a cutoff frequency calculated by multiplying a preset bandwidth by a predetermined ratio (20%, 40%, 60%), so that the time width of a each pulse may be reduced.

The probe phase modulation unit 121 may be configured to output the probe optical signal distributed from the distribution unit 102 by modulating its phase according to the first PRBS signal generated from the PRBS generation unit 110.

The pump phase modulation unit 122 may be configured to output the pump optical signal distributed from the distribution unit 102 by modulating its phase according to the second PRBS signal generated from the PRBS generation unit 110.

The present disclosure is configured to generate a time difference of the pulse pattern signal in a unit shorter than the time interval of one bit between the probe and the pump before phase-modulating both of them, and to distort the pulse waveform for each bit in the pulse pattern signal, whereby the spatial resolution may be improved compared to the optical fiber measurement technology based on the BOCDA sensor using the existing PRBS.

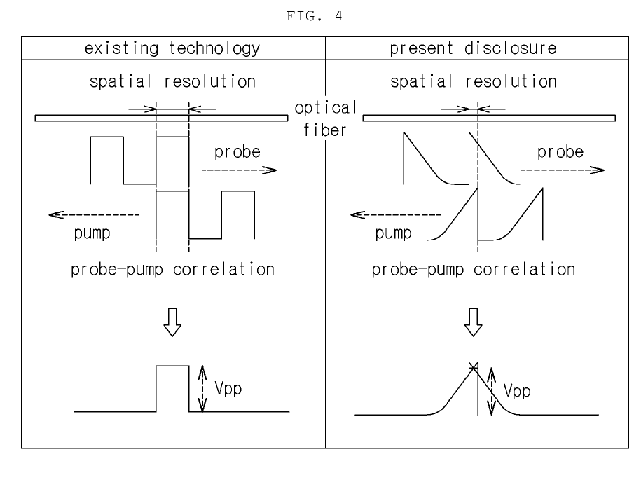

Referring to FIG. 4, it may be confirmed that the spatial resolution according to the correlation between the probe signal and the pump signal with a time difference in the existing technology is in the time interval of one bit.

Since the existing technology has the characteristic that the pulse wave for one bit is a square wave, even when a delay in a time interval shorter than the time interval of one bit is applied, which is one of the features of the present disclosure, the spatial resolution is still in the time interval of one bit.

Meanwhile, the present disclosure distorts the pulse waveform for each bit in the pulse pattern signal so that the time width is significantly reduced compared to the time interval of one bit, thereby reducing the spatial interval at which the correlation gain occurs, whereby the position at which the correlation gain occurs may be finely adjusted.

That is, the present disclosure may be configured to provide a time difference shorter than one bit to the pulse pattern signal while simultaneously distorting the waveform, thereby improving the spatial resolution compared to the existing technologies at the same modulation rate.

The BOCDA sensor unit 130 may include a sensing optical fiber 140. The BOCDA sensor unit 130 may measure a Brillouin gain spectrum by inputting the probe signal and the pump signal with a time difference, which are generated according to the outputs from the probe phase modulator 121 and the pump phase modulator 122, to both ends of the sensing optical fiber 140.

The BOCDA sensor unit 130 may include the sensing optical fiber 140, a single side band modulator 131, a first optical fiber amplifier 132, a polarization scrambler 133, an optical isolator 134, an optical chopper 135, a second optical fiber amplifier 136, an optical fiber circulator 137, an optical detection unit 138, and a lock-in amplifier unit 139.

The single side band modulator 131 may receive the phase-modulated probe optical signal output from the probe phase modulator 121 and then re-modulate the probe optical signal which is modulated in phase so that the carrier frequency is at most 11 GHz lower than the pump optical signal. When the probe optical signal and the pump optical signal meet in the sensing optical fiber 140, this frequency shift enables SBS gain generation.

The first optical fiber amplifier 132 may amplify and output the output of the single side band modulator 131.

The polarization scrambler 133 may remove polarization from the output of the first optical fiber amplifier 132.

The optical isolator 134 may be configured to send the optical signal output from the polarization scrambler 133 to one end of the sensing optical fiber 140 and block the optical signal output from one end of the sensing optical fiber 140.

The optical chopper 135 may be installed between the pump phase modulation unit 122, the second optical fiber amplifier 136, and the lock-in amplifier unit 139 to assist the operation of the lock-in amplifier unit 139 by periodically blocking the optical signal.

The second optical fiber amplifier 136 may be configured to amplify the output of the pump phase modulation unit 122.

The first optical fiber amplifier 132 and the second optical fiber amplifier 136 may be implemented as an EDFA (Erbium Doped Fiber Amplifier), but are not limited thereto.

The optical circulator 137 may be configured to send the optical signal output from the second optical fiber amplifier 136 to the other end of the optical fiber 140, and send the optical signal output from the other end of the sensing optical fiber 140 to the optical detection unit 138.

The optical detection unit 138 may be configured to convert the optical signal output from the optical circulator 137 into an electrical signal.

The lock-in amplifier unit 139 may be configured to amplify the electrical signal converted by the optical detection unit 138 in conjunction with the optical chopper 135.

The technical feature of the present disclosure is that it generates a time difference with a sub-bit interval of less than the time interval of one bit between each pseudo-random bit sequence which is applied to the probe signal and the pump signal to be modulated in phase, to allow the correlation gain position to be allocated with an interval shorter than the time interval of one bit, thereby improving the spatial resolution. The BOCDA sensor unit 130 may be applied to BOCDA sensors of another structure that receive probe signals and pump signals with a time difference across both ends and measures the Brillouin frequency based on Brillouin correlation analysis, even when it does not have the structure described above.

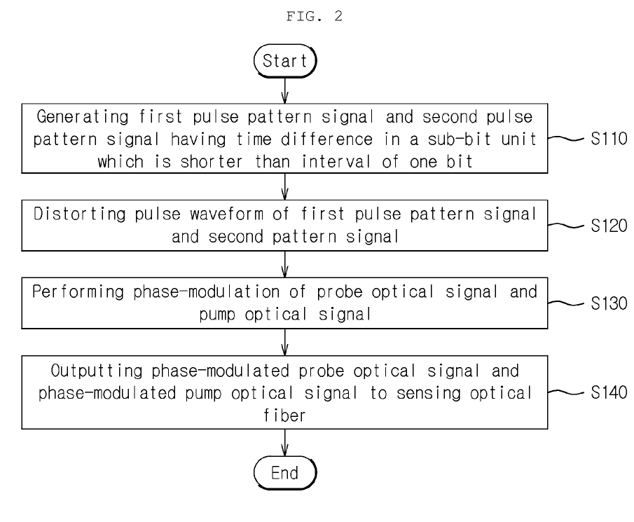

Referring to FIG. 2, a method for optical fiber measurement based on Brillouin optical correlation domain analysis using pulse waveform control of bits according to another embodiment of the present disclosure may include a step S110 of generating two identical electrical pulse pattern signals to be modulated in phase so that a probe optical signal and a pump optical signal have a time difference according to a pseudo-random bit sequence, the two identical electrical pulse pattern signals being generated to have a time difference of a sub-bit unit shorter than a time interval of one bit, a step S120 of generating a first PRBS signal and a second PRBS signal by distorting a per-bit pulse waveform of each of the two identical electrical pulse pattern signals, a step S130 of performing phase modulation of the probe optical signal and the pump optical signal distributed from a light source according to the first PRBS signal and the second PRBS signal, respectively; and a step S140 of outputting the phase-modulated probe optical signal and the phase-modulated pump optical signal to both ends of a sensing optical fiber.

The step S120 of generating a first PRBS signal and a second PRBS signal by distorting a per-bit pulse waveform of each of the two identical electrical pulse pattern signals may be performed by distorting the waveforms of the first pulse pattern signal and the second pulse pattern signal by performing RF amplification of the first pulse pattern signal and the second pulse pattern signal respectively, according to a cutoff frequency limited to block a low frequency by a predetermined ratio in a preset bandwidth.

In the method for optical fiber measurement based on Brillouin optical correlation domain analysis using pulse waveform control of bits according to another embodiment of the present disclosure, the step S110 of generating the first PRBS signal and the second PRBS signal may be implemented by the PRBS generation unit 110 of the apparatus 100 for optical fiber measurement based on Brillouin optical correlation domain analysis using pulse waveform control of bits according to an embodiment of the present disclosure, and the step S130 of causing the optical signals to be modulated in phase and the step S140 of outputting the phase-modulated optical signals to both ends of a sensing optical fiber may be implemented by the probe phase modulation unit 121 and the pump phase modulation unit 122. For the convenience of explanation, parts that are functionally identical will not be described repeatedly.

Meanwhile, the blocks of the attached block diagram and the steps of the flowchart may be implemented as computer instructions that are loaded into a processor or memory of an electronic device capable of data processing (e.g., a general-purpose computer, a special-purpose computer, a portable notebook computer, a network computer) and perform designated functions. Since these computer program instructions may be stored in a computer-readable memory, the functions described in the blocks of the block diagram or the steps of the flowchart may be produced as a manufactured product that includes a command means for performing them.

Hereinafter, an experiment conducted to confirm that the spatial resolution is improved according to embodiments of the present disclosure will be described.

In actual optical fiber measurements, a single optical fiber is used to measure the frequency at which the correlation gain occurs, which varies with changes in pressure or temperature, whereas in the laboratory, the spatial resolution of the strain change was confirmed by using various types of optical fibers with different Brillouin frequency values at which the gain occurs, as a method of simulating this adjustment.

According to theory, the theoretical resolution limit for enabling measurement at 20 Gbps in the existing TD-BOCDA-based optical fiber measurement technology is 5 mm, and in the embodiments of the present disclosure, the Brillouin frequency was measured in sensing optical fibers of 100 m including DSFs (Dispersion Shifted Fibers) of 5 mm and 10 mm and the rest consisting of SSMFs (Standard single mode optical fibers) using a PRBS generator that did not apply sub-bit delay.

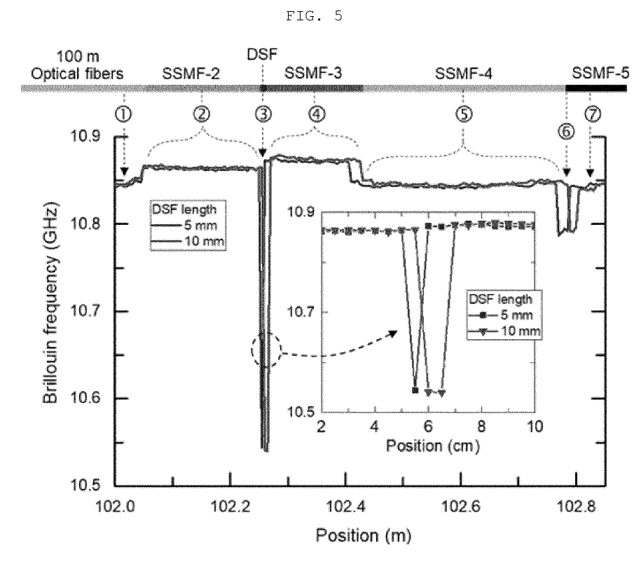

Referring to FIG. 5, the results of measuring the Brillouin frequency is shown using the existing method at a bit rate of 20 Gbps for the sensing optical fiber provided by fusion-bonding various types of optical fibers (SSMF-2, DSF, SSMF-3, SSMF-4, and SSMF-5) at the end of the optical fibers of 100 m. The DSF used was tested separately for 5 mm and 10 mm, and it was confirmed that the positions of the SSMFs and DSF used in both cases were clearly identified. The DSF of 5 mm showed one measuring point and the 10 mm DSF showed two measuring points, which is consistent with the fact that the resolution limit of the measuring apparatus is 5 mm.

However, the existing technology cannot secure a spatial resolution shorter than 5 mm at a bit rate of 20 Gbps.

Then, in order to verify that a spatial resolution shorter than 5 mm may be implemented at a bit rate of 20 Gbps according to the present disclosure, the Brillouin frequency was measured in a sensing optical fiber of 100 m including DSF of 1 mm and the rest consisting of SSMFs using a PRBS generator that applied sub-bit delays of various intervals and a generator that did not apply sub-bit delays, according to embodiments of the present disclosure.

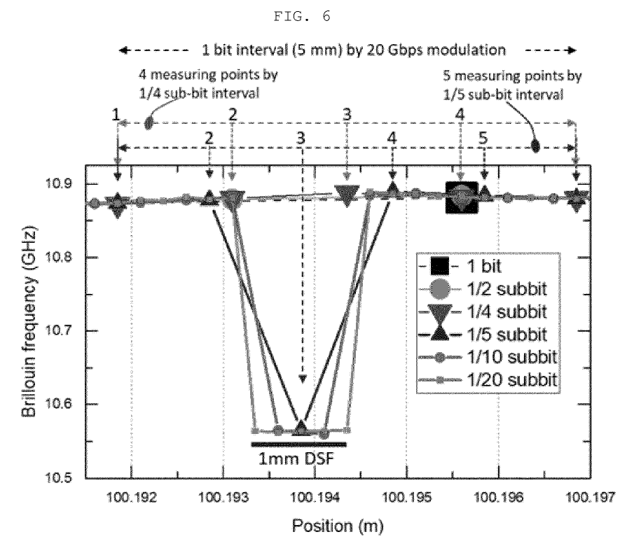

Referring to FIG. 6, in the case of applying a 1/2 sub-bit and applying a 1/4 sub-bit, the DSF of 1 mm was not measured, as in the case of applying no sub-bit (applying 1 bit). In the cases of 1/2 sub-bit having a resolution of 2.5 mm, which is a half of 5 mm in bit delay resolution, and 1/4 sub-bit having a resolution of 1.25 mm, the resolution is improved compared to when no sub-bit is applied (1 bit is applied). However, since the length of the optical fiber to be measured is 1 mm, the Brillouin frequency of the DSF could not be measured.

However, when 1/5 sub-bit was applied, the resolution was 1 mm, in which a DSF of 1 mm was measured at one point, as shown in FIG. 6. When 1/10 sub-bit was applied and 1/20 sub-bit were applied with higher resolution, it was confirmed that the DSF length could be measured more specifically.

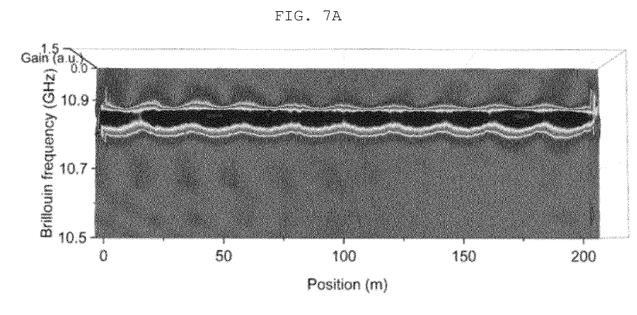

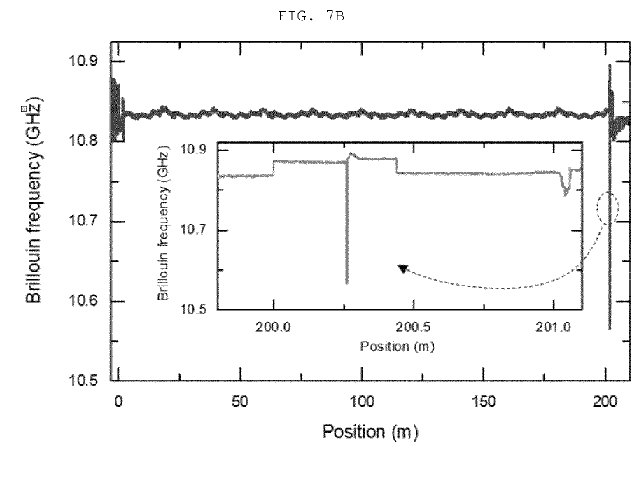

FIG. 7A and 7B show the results of placing a DSF of 1mm at the end of a sensing optical fiber of 200m and then measuring the Brillouin frequency of the entire optical fiber, and in particular, FIG. 7B is an enlarged view showing the Brillouin frequency measurement value around the DSF optical fiber located at the end of the sensing optical fiber of 200m, in which it may be confirmed that the position of the DSF optical fiber of 1mm is clearly measured. The figure inserted in the middle of FIG. 7B is an enlarged view of the position where the DSF of 1mm is included at the end of the sensing optical fiber of 200m, in which the position where the Brillouin frequency drops below 10.6GHz near 200.25m may be confirmed. This position represents the measured DSF of 1mm, and the different Brillouin frequency values around this position are measured by the SSMF used together. It may be appreciated that the present disclosure allows the 1mm resolution to be maintained up to a distance of 200m or more.

In summary, according to the present disclosure, when a time difference is introduced between a probe signal and a pump signal based on a pseudo-random bit sequence, the two identical electrical pulse pattern signals are delayed by an amount shorter than the time interval of one bit., a pulse waveform for each bit is distorted to reduce the time interval, and the probe optical signal and the pump optical signal are phase-modulated, thereby improving the spatial resolution compared to the existing TD-BOCDA-based optical fiber measurement technology at the same bit modulation rate.

Therefore, it is expected that the efficiency and performance of the fiber optic measurement system will be improved by reducing the spatial resolution without drastically increasing the bit modulation rate, which requires high costs.

Those skilled in the art will understand that the present disclosure may be implemented in other specific forms without changing the technical idea or essential features thereof. Therefore, it should be understood that the embodiments described above are exemplary in all respects and not limiting. The scope of the present disclosure is indicated by the scope of the claims described below rather than the detailed description above, and all changes or modifications derived from the scope of the claims and their equivalent concepts should be interpreted as being included in the scope of the present disclosure.

### Description of Reference Numerals

1000: Apparatus for optical fiber measurement based on Brillouin optical correlation domain analysis using pulse waveform control of bits

101: Light source unit

102: Distribution unit

110: PRBS generation unit

111: Pulse pattern generation unit

112: Delay unit

113: First RF amplifier

114: Second RF amplifier

121: Probe phase modulation unit

122: Pump phase modulation unit

130: BOCDA sensor unit

What is claimed is:

1. An apparatus for optic fiber measurement based on Brillouin optical correlation domain analysis using pulse waveform control of bits, the apparatus comprising:
a PRBS generation unit generating two identical electrical pulse pattern signals to be modulated in phase so that a probe optical signal and a pump optical signal have a time difference according to a pseudo-random bit sequence, the two identical electrical pulse pattern signals being generated to have the time difference in a sub-bit unit which is shorter than a time interval of one bit, and generating a first PRBS signal and a second PRBS signal by distorting a per-bit pulse waveform of each of the two pulse pattern signals;
a probe phase modulation unit performing phase modulation of the probe optical signal according to the first PRBS signal;
a pump phase modulation unit performing phase modulation of the pump optical signal according to the second PRBS signal; and
a BOCDA sensor unit having a sensing optical fiber and measuring a Brillouin gain spectrum by inputting the probe optical signal and the pump optical signal with the time difference, which is generated according to outputs from the probe phase modulation unit and the pump phase modulation unit, to both ends of the sensing optical fiber.

2. The apparatus of claim 1, wherein the PRBS generation unit generates a first pulse pattern signal of a square wave according to a pseudo-random bit sequence, generates a second pulse pattern signal by delaying the first pulse pattern signal in a sub-bit interval unit divided into a sub-unit within a time interval of one bit, and generates the first PRBS signal and the second PRBS signal by distorting waveforms of the first pulse pattern signal and the second pulse pattern signal.

3. The apparatus of claim 2, wherein the PRBS generation unit comprises:
a pulse pattern generation unit generating the first pulse pattern signal of the square wave according to the pseudo-random bit sequence;
a delay unit generating the second pulse pattern signal by delaying the first pulse pattern signal in a sub-bit interval unit divided into a sub-unit within a time interval of one bit; and
a first RF amplifier and a second RF amplifier distorting the waveforms of the first pulse pattern signal and the second pulse pattern signal by performing RF amplification of the first pulse pattern signal and the second pulse pattern signal respectively, according to a cutoff frequency limited to block a low frequency by a predetermined ratio in a preset bandwidth.

4. A method performed by an electronic apparatus, the method comprising:
generating two electrical pulse pattern signals to be modulated in phase so that a probe optical signal and a pump optical signal have a time difference according to a pseudo-random bit sequence, the two identical electrical pulse pattern signals being generated to have a time difference of a sub-bit unit shorter than a time interval of one bit;
generating a first PRBS signal and a second PRBS signal by distorting a per-bit pulse waveform of each of the two pulse pattern signals;
performing phase modulation of the probe optical signal and the pump optical signal distributed from a light source according to the first PRBS signal and the second PRBS signal, respectively; and
outputting the phase-modulated probe optical signal and the phase-modulated pump optical signal to both ends of a sensing optical fiber.

5. The method of claim 4, wherein the generating the two electrical pulse pattern signals comprises:
generating a first pulse pattern signal of a square wave according to a pseudo-random bit sequence;
generating a second pulse pattern signal by delaying the first pulse pattern signal in a sub-bit interval unit divided into a sub-unit within a time interval of one bit; and
distorting waveforms of the first pulse pattern signal and the second pulse pattern signal.

6. The method of claim 5, wherein the distorting the waveforms of the first pulse pattern signal and the second pulse pattern signal comprises:
distorting the waveforms of the first pulse pattern signal and the second pulse pattern signal by performing RF amplification of the first pulse pattern signal and the second pulse pattern signal respectively, according to a cutoff frequency limited to block a low frequency by a predetermined ratio in a preset bandwidth.
